(19) United States
(12) Patent Application Publication
(10) Pub. No.: US 2009/0040874 A1
(43) Pub. Date: Feb. 12, 2009

(54) Medication Reminder System and Method

(75) Inventors: John Rooney, Redding, CA (US); Michael Rooney, Visalia, CA (US)

Correspondence Address: PROCOPIO, CORY, HARGREAVES & SAVITCH LLP, 530 B STREET, SUITE 2100, SAN DIEGO, CA, 92101, US

(73) Assignee: ROONEY WORLD CORP., Visalia, CA (US)

(21) Appl. No.: 12/186,000

(22) Filed: Aug. 5, 2008

Related U.S. Application Data
(60) Provisional application No. 60/954,632, filed on Aug. 8, 2007.

(51) Int. Cl. G04B 47/00; G04F 10/00

(52) U.S. Cl. 368/10; 368/109

(57) ABSTRACT

A medication reminder system has a carrier device which is carried or worn by a user and a medication alert assembly or module associated with the carrier device. The medication alert assembly has at least one alarm device which produces a first alarm signal to remind the user to take a medication, a controller which controls actuation of the first alarm device, a timer associated with the controller having a pre-set time interval corresponding to a standard dosage time in hours between doses of the medication, the controller activating the first alarm device to emit an alarm signal on expiry of the pre-set time interval, and a reset switch operable by the user which deactivates the first alarm device and restarts the timer after each alarm activation.

### RELATED APPLICATION

The present application claims the benefit of co-pending U.S. provisional patent application No. 60/954,632 filed Aug. 8, 2007, which is incorporated herein by reference in its entirety.

### BACKGROUND

1. Field of the Invention

The present invention relates generally to a reminder system and method which provides automatic alarm signals at pre-selected intervals to remind a user to perform an action, and is particularly concerned with a medication reminder system to remind a user to take a medication at pre-determined intervals.

2. Related Art

It is well known that patients who are prescribed medications, or who take over the counter (OTC) medications, should take such medications at pre-determined dosage time intervals as prescribed by the doctor or as indicated on the OTC medication package. Many drugs and medications currently prescribed by physicians must be taken at prescribed time intervals. If the patient ignores such instructions, for example, by taking the prescribed medication too often or too seldom, this may result in serious adverse effects such as overdose risks or reduction in the concentration of medication in the body. Many patients miss dosages because they are distracted or forget about their medications at the correct dosage time. This is particularly true of elderly patients who may be taking more than one medication at different time intervals. Although patients may set an alarm clock or the like at a prescribed medication time interval, they may set the incorrect time interval or may forget to re-set the alarm after taking a medication dose, and may also be away from the alarm and not hear it when it goes off.

When required to take medicine on a daily or hourly schedule, many people have a problem in recalling the time when the medicine was last taken. Similarly, many patients are unable to remember or determine the previous dosage of medication taken or whether it has been taken at all. This problem is particularly common among elderly patients, who may experience short-term memory loss or, because of their infirmities, confuse the dosage previously taken of each medication. Patients may also be unable to accurately read the medication containers themselves, and often have no means to determine whether they have taken the mandated doses at the prescribed time intervals.

Various means and methods have come into use for reminding or prompting one to utilize medication at a scheduled time. A general approach to the problem relies upon the use of calendar indicators, timers, or other standard time-keeping devices which can be set to calculate the time at which the next medication must be taken. However, most of such time reminders are dependent upon a device, such as a container for pills or the like, which is discarded when empty or after an illness is cured. The user is typically required to remove their multiple medications from the original containers, sort the various medications according to dosage time, and distribute the various medications in the medication containers. This can cause confusion for elderly patients and also deprives the user of the availability of the dosage instructions provided on the original containers.

There are some prior art wrist watch-like appliances for providing medication reminders, but these are quite complex to use, often require extensive programming or user input for each particular medication to be taken, and may be difficult for a patient to set up correctly. Such appliances are described, for example, in U.S. Pat. No. 5,861,797 of Becker and U.S. Pat. No. 6,560,165 of Barker. The existing electronic medication timing devices of the prior art, such as count-down timers, interval timers, clocks, watches and the like can facilitate the intake of medication at regular intervals. With such devices, the user needs to program the timing device to establish the designated time for alert indications, which can be a complicated process. Older and infirm people are frequently incapable of setting such a programming sequence with these devices. In addition, such devices generally require a visual display such as a liquid crystal display to assist in the program procedure, which in turn adds to the cost, size and complexity of the medication timing device. Finally, most existing medication timing devices do not have the ability to repeat the sound or indication once it is produced. If the user fails to notice the originally produced indication, it often results in lapse of medication.

There is therefore a need for a simpler medication reminder system and method which is easy for a patient to use.

### SUMMARY

According to one aspect, a medication reminder system is provided which comprises a carrier or holder device, and an alarm or medication alert assembly associated with the carrier device. The medication alert assembly comprises at least one alarm device which produces a first alarm signal to remind the user or patient to take a first selected medication, a controller which controls actuation of the alarm device, a timer associated with the controller having at least a first pre-set time interval comprising a pre-determined number of hours corresponding to a standard dosage time in hours between doses of the first selected medication, the controller actuating the alarm device to emit an alarm signal on expiry of the pre-set time interval, and a reset switch operable by the patient which deactivates the alarm device and restarts the timer after each alarm activation. The carrier or holder device in one embodiment is designed to be worn or carried by a user.

Components of the medication alert assembly may be incorporated in the carrier device, or all or part of the assembly may be formed as a module permanently or releasably secured to the carrier device. In one embodiment of the system, a plurality of disposable carrier devices are provided, each associated with a medication alert assembly having a timer associated with one standard medication dosage time interval different from the time intervals associated with timers in the other carrier devices. In another embodiment, the medication alert assembly is incorporated in a module which is releasably securable to a carrier device. A plurality of different medication alert modules may be provided, each having a timer associated with a standard medication dosage time interval. The appropriate module is selected and attached to the carrier device, depending on the medication dispensed. Some modules may have timers having two or more different time intervals for use by patients taking more than one medication, and different alarm devices or different alarm sequences are activated by the controller on expiry of the different timed intervals. In each case, the patient does not have to program their own medication reminder system, but instead has a simple, easy to carry or wear device. All the patient needs to do is to take a dose of medication when the alarm is activated, and then press the reset switch to turn off the alarm and re-start the timer for the next scheduled dose.

This medication system is simple to use and requires no special set up or programming, since each medication reminder device or alert module is already set up with a pre-determined dosage time interval, and can be started with a simple press of a button. The user is unlikely to miss a dose since the alarm signal repeats until the reset button is pressed. The individual medication reminder devices or medication alert modules require only a few components, have no visual information display, and are quite inexpensive. The modules or reminder devices may be designed to be disposable after use. In one embodiment, the modules or carrier devices may have different visual appearances or indicia so as to indicate the different time intervals, such as different colors, bar codes, or the like, or may have indicia corresponding to certain medications or to the specific medication time interval.

In another embodiment, the timer includes a plurality of different time intervals and may be pre-set with the appropriate time interval for a particular medication by a doctor or pharmacist. The carrier device is then provided to a patient, and can be worn or carried by the patient. When the alarm device is activated, all that the patient needs to do is take the medication and then press the reset switch to re-start the timer and turn off the alarm.

The carrier device may be a wrist strap, bracelet, key FOB, necklace, or a clip which clips onto a waistband or elsewhere on the patient's clothing. As noted above, the medication alert assembly may be permanently incorporated in the carrier device, or some or all of the components of the medication alert assembly may be enclosed in a housing permanently or releasably secured to the carrier device, to form a medication alert module. When the medication alert module is releasably securable to a carrier device, a patient may be provided with different carrier devices and may choose the manner in which they prefer to carry the medication alert module, for example on a wrist band, clip, or key fob. The user or patient may switch between different carrier devices if desired. In one example, the medication alert module and the carrier devices may have interengageable snap fasteners. Alternatively, the medication alert module may be designed for sliding engagement on rails provided on the various carrier devices.

This medication reminder system and method is easy for a patient to use since they do not have to program the system, but instead only have to take a dose of medication and press a reset button each time the alarm is activated.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a perspective view of a first embodiment of a medication reminder system or device which has a medication alert or alarm module attached to a wrist strap;

FIG. 2 is a perspective view of the wrist strap of FIG. 1 attached to a person's wrist;

FIG. 3 is a perspective view of a second embodiment of a medication reminder system or device which has a medication alert or alarm module attached to a clip;

FIG. 4 is a side elevation view of the device of FIG. 3;

FIG. 5 is a side elevation view of a medication reminder system similar to FIG. 4 but with a modified medication alert module;

FIG. 6 is a top plan view of a third embodiment of a medication reminder system which has a medication alert or alarm module incorporated in a key fob;

FIG. 7 is a top plan view similar to FIG. 6 illustrating a modified key fob incorporating a pill compartment;

FIG. 8 is a schematic block diagram of a control circuit for use in any of the systems of FIGS. 1 to 7;

FIG. 9 is a more detailed functional block diagram of the control circuit;

FIGS. 10A to 10D illustrate parts of one embodiment of a modular medication reminder system comprising a medication alert module and a plurality of different types of carriers to which the module can be releasably secured;

FIG. 11 is a perspective view illustrating the removable medication alert or alarm module of FIG. 10A attached to the wrist band of FIG. 10B;

FIG. 12A is a perspective view of a wrist band of a second embodiment of a modular medication reminder system with a removable medication alert module partially engaged with the wrist band;

FIG. 12B is a perspective view of a clip device forming another part of the modular system of FIG. 12A, with the removable medication alert module of FIG. 12A partially engaged with the device;

FIG. 12C is a perspective view of a key fob forming another part of the modular system of FIGS. 12A and 12B, with the removable medication alert module partially engaged with the device;

FIG. 13 is a top plan view of another embodiment of a medication reminder device;

FIG. 14 is a side elevation view of the device of FIG. 13;

FIG. 15 is a cross-sectional view generally along lines 15-15 of FIG. 13, with an access door or cover of the alarm actuator compartment in an open position;

FIG. 16 is a bottom plan view of the device with cover in the open position of FIG. 15;

FIG. 17 is a cross-sectional view similar to FIG. 15 but illustrating a modified medication reminder device with a different fastener mechanism;

FIG. 18 is block diagram of one embodiment of an alarm actuator circuit for the medication reminder devices of FIGS. 13 to 17;

FIG. 19 is a perspective view of the medication reminder device of FIGS. 13 to 16 or 17 worn on a person's wrist;

FIG. 20 is a bottom plan view of part of a medication reminder device similar to the devices of FIGS. 13 to 17 but with a different, one-time fastener mechanism for securing the device around a person's wrist; illustrating the alarm actuator compartment with the cover removed to reveal the components of the alarm actuator circuit;

FIG. 21 is a top plan view of the part of the device illustrated in FIG. 20 prior to battery activation; and

FIG. 22 is a bottom perspective view of the part of the device illustrated in FIG. 21 with the cover of the alarm actuator compartment in place.

### DETAILED DESCRIPTION

Certain embodiments as disclosed herein provide for a medication reminder device or system which has a medication alert assembly associated with a holder or carrier device which can be worn or carried by a patient. The medication alert assembly is modular and removably attached to the carrier device in some embodiments, and is incorporated in the carrier device in other embodiments. In each case, the medication alert assembly produces an alarm signal after a pre-determined time interval has expired to alert the patient that it is time to take a dose of medication.

After reading this description it will become apparent to one skilled in the art how to implement the invention in various alternative embodiments and alternative applications. However, although various embodiments of the present invention will be described herein, it is understood that these embodiments are presented by way of example only, and not limitation.

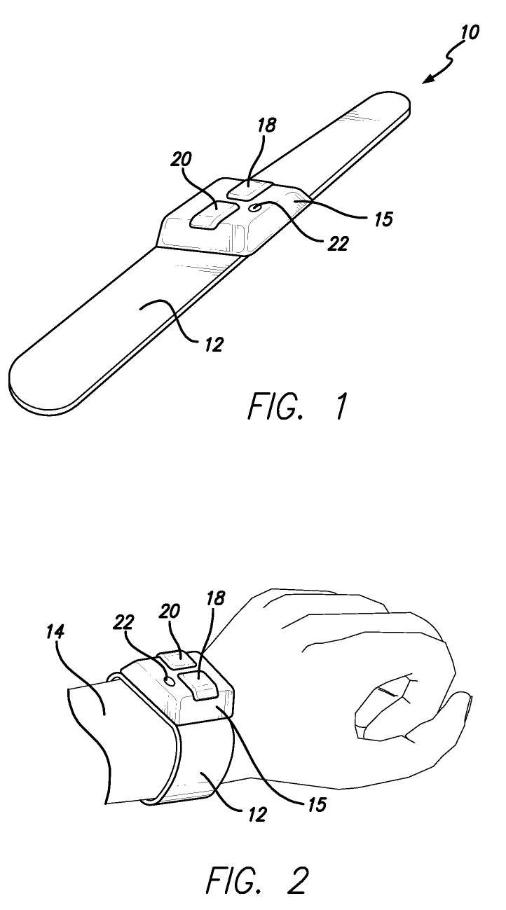

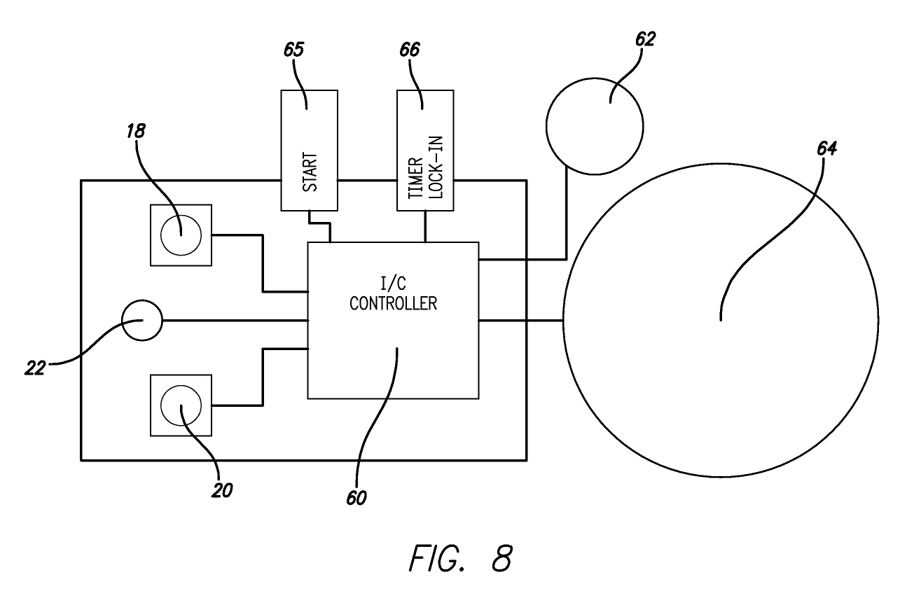

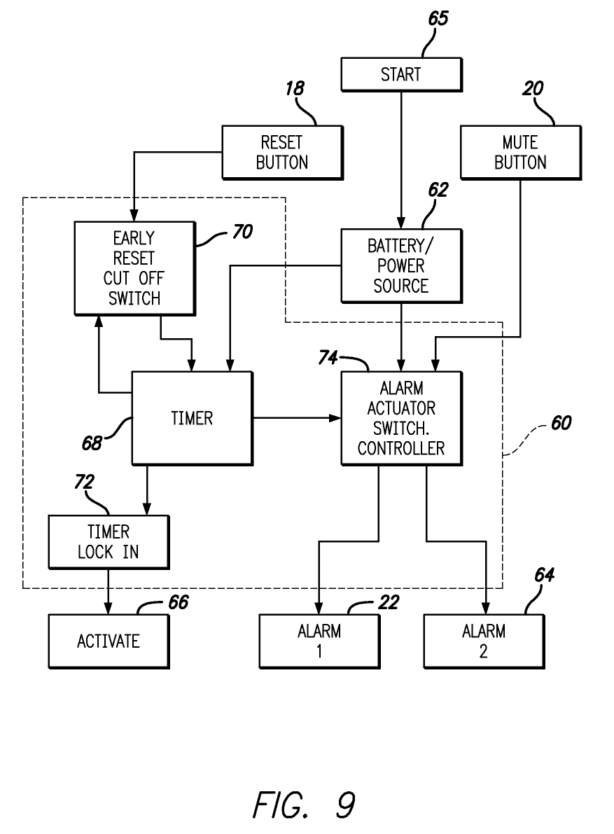

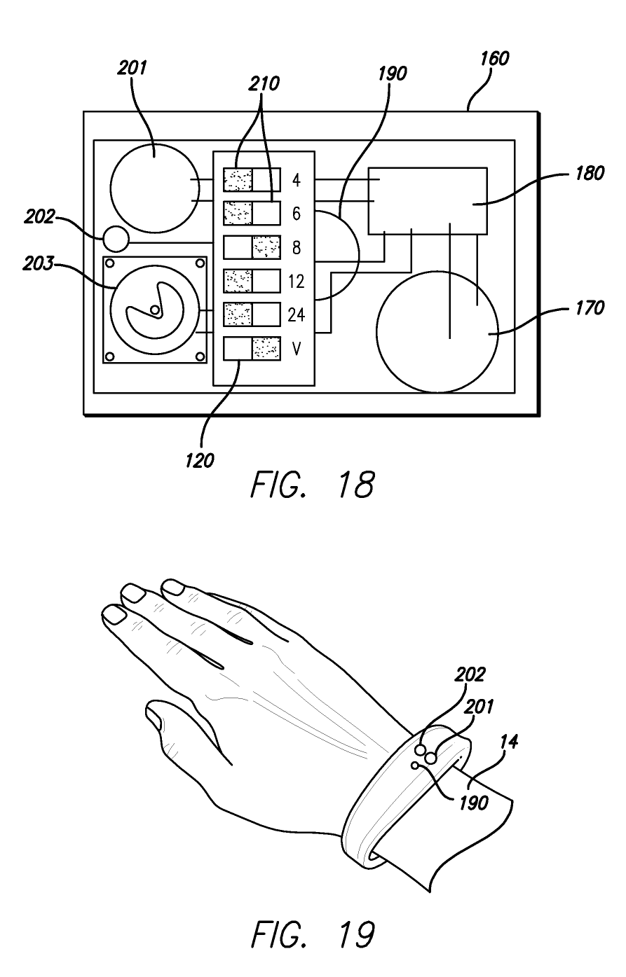

FIGS. 1 and 2 illustrate a first embodiment of a medication reminder system 10 comprising a carrier device in the form of a wrist band or strap 12 which can be worn about the wrist 14 of a user or patient, and a medication alert assembly or module 15 which may be permanently or temporarily attached to wrist band 12. The medication reminder system 10 may be designed to be disposable after a course of medication is completed, or may be re-usable for successive prescriptions with adjustment of the medication alert module if needed. The medication alert module 15 has a manually operable reset button 18 and an optional mute button 20 on its upper surface, along with an alarm device 22 which may be a visual alarm such as a light emitting diode (LED), an audible alarm device, or other types of alarm device. In alternative embodiments, more than one alarm device may be provided, such as both LED and audible alarm devices. If the module contains no audible alarm device, the mute button may be eliminated. A tactile alarm device such as a vibrator may also be incorporated on the lower surface of wrist band 12, for example as described below in connection with the embodiment of FIGS. 18 to 22. A controller or control circuit for actuating the alarm device or devices is enclosed inside unit 15 and is connected to the mute and reset buttons 18 and 20, as described in more detail below in connection with FIGS. 8 and 9. Although not illustrated in FIGS. 1 and 2, a medication container may also be incorporated in another embodiment of the system 10.

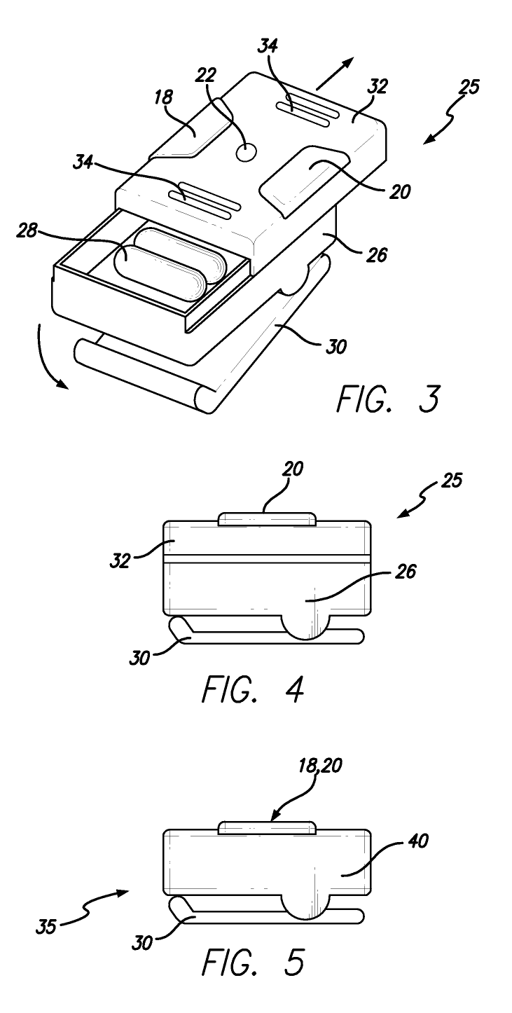

FIGS. 3 and 4 illustrate a second embodiment of a medication reminder system having a carrier device 25 in the form of a clip-on mechanism having a compartment 26 for containing medication such as pills 28, a clip member 30 hinged to a lower wall of compartment 26, and a medication alert unit or module 32 slidably engaged over the open top of compartment 26 for movement between an open position as illustrated in FIG. 3 to allow access to the contents of compartment 26 and a closed position covering the open top of the compartment. In this case, the medication alert unit or module 32 also forms a cover or lid for the medication compartment. As in the previous embodiment, medication alert module 32 has a reset button 18 and a mute button 20 on its upper surface, as well as an LED indicator 22, and contains a control circuit (not visible in FIG. 3) connected to buttons 18, 20 and LED 22. Module 32 may also include an audible alarm or other alarm device (not visible in FIG. 3). Ribs or ridges 34 may be engaged by a user to assist in opening and closing the medication compartment 26. The clip member 30 is spring loaded into the closed position of FIG. 4 and can be urged by a user into the open position of FIG. 3 (with the medication compartment 26 closed) to be attached at any convenient location to a person's clothing or accessory, such as to a belt, waist band, pocket, purse, or the like.

FIG. 5 illustrates a modified medication reminder system or device 35 which is similar to the device of FIGS. 3 and 4, but which does not include a pill compartment. Instead, the clip member 30 is directly attached to a medication alert module 40 which includes the reset and mute buttons 18, 20 and LED indicator 22 of FIGS. 3 and 4, and which contains the same control circuit which operates the LED and an optional audible alarm as described below in connection with FIGS. 8 and 9.

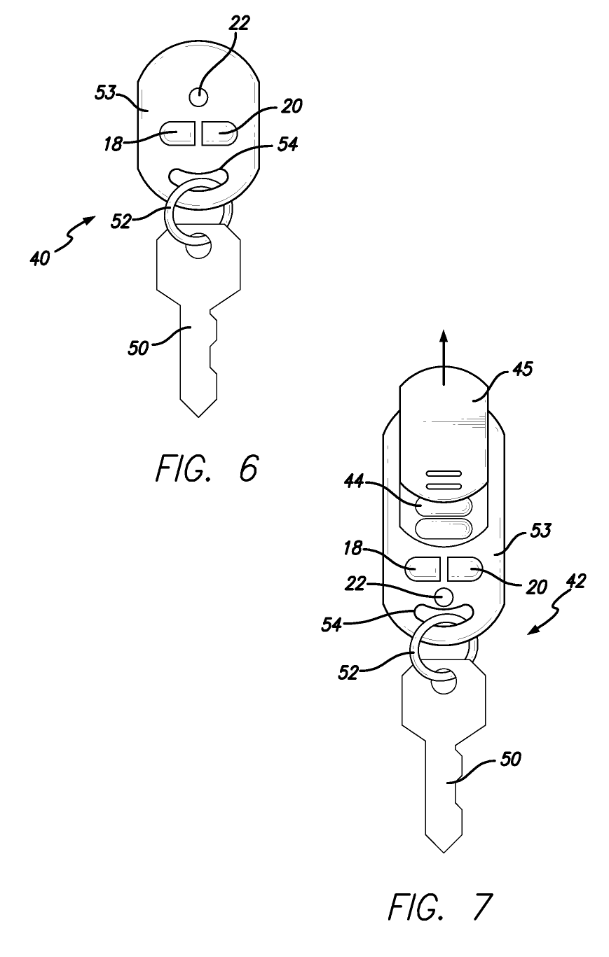

FIGS. 6 and 7 illustrate modified medication reminder devices 40 and 42 in the form of key fobs incorporating components of a medication alert assembly, with the key fob 42 of FIG. 7 including a medication compartment 44 closed by a sliding door or cover 45. Both key fobs 40 and 42 comprise a housing 53 which contains a control circuit for operating one or more alarm devices such as an LED 22. The control circuit is connected to reset and mute buttons 18, 20 on the top of the housing, as described below in connection with FIGS. 8 and 9. Each key fob has an opening 54 at one end of the housing. One or more keys 50, cards, or other items may be attached to the key fob via a ring 52 extending through opening 54 at one end of the housing.

FIG. 8 is a schematic block diagram of one embodiment of a control circuit which may be mounted in the medication alert module 15 of the wrist band device of FIGS. 1 and 2, the medication alert unit or module 32 or 40 of the clip-on devices of FIGS. 3 and 4 or 5, or the key fobs 40 or 42 of FIGS. 6 and 7. In each case, the control circuit is housed in a chamber or internal compartment of the medication alert module or the carrier device itself, where there is no separate medication alert module. The control circuit compartment may be accessible by a door or cover for battery replacement purposes in some embodiments, as described in connection with the embodiments of FIGS. 13 to 22 described below. In other embodiments where the medication reminder device is disposable after use, the control circuit compartment may be inaccessible.

As illustrated in FIG. 8, the control circuit comprises a controller or integrated circuit (IC) 60 which is programmed with one or more alarm delay times corresponding to the time periods or intervals between successive doses of medication. A suitable power source such as a battery 62 is connected to IC 60. The battery may be a disposable, small size lithium or alkaline battery, or may be a rechargeable battery where the device is reusable. The IC has control inputs from the reset button 18 and the optional mute button 20, and control outputs connected to alarm devices such as LED 22 and an audible alarm device 64 such as a piezoelectric transducer device. The circuit of FIG. 8 also includes an optional start or activate tab 65 which may be used to activate the control circuit and/or battery 62, and an optional lock tab 66 which may be used to lock in a selected timing program.

In embodiments where the medication alert device or module is a single use device which is intended to be discarded after completion of a course of medication, an optional “kill-switch” may also be provided in the control circuit, to ensure that the alarm does not continue to go off after it is discarded in a trash can or the like. The kill switch may be activated by holding down the reset button for an extended time period, for example a time period of the order of seven to ten seconds. A red LED on the device blinks and an audio signal alerts the user that the device is being turned off. If the reset button is accidentally held down for the requisite time period, causing the alarm sequence to terminate, a patient could hold it down again for the extended time period, causing the device to re-start. When the device is re-started, a green LED light and an audio chirp or the like notifies the patient that the device is back on. In one example of a possible “kill switch”, the reset button is held down for 15 seconds to deactivate the device, but a different time period may be selected in other embodiments. The time sequence in this example is as follows:
from 0 sec. to 5 sec. no alarms
from 5 sec. to 15 sec. audio alarm starts to beep (0.125 second beep, 4 beeps per second)
after the 15 seconds, a 2 second long constant audio tone and constant LED verifies deactivation. The continual LED will drain the remaining power for safe disposal. The device cannot be reactivated once the constant audio tone and LED are activated.

FIG. 9 is a more detailed function block diagram of the medication alert assembly or module including some functional modules of the IC 60. As illustrated, IC 60 includes a timer module 68, an early reset cut off or protection module or switch 70, an optional timer lock-in module 72, and an alarm actuator switch 74. The alarm actuator switch 74 has control outputs to the alarm devices 22 and 64 (and to other alarm devices such as a tactile device if present), and is connected to the battery 62 and mute button 20. Reset button 18 is connected to the timer module 68 via early reset cut off switch or module 70. The optional start or activate tab 65 is connected to the battery, and the optional lock tab 66 is connected to a timer lock-in module 72 of timer module 68. The lock tab and timer lock-in module 72 are eliminated in embodiments in which the timer is associated with one factory pre-set or preprogrammed time interval, and the start tab 65 may also be eliminated in some embodiments. The system in such embodiments is turned on or activated simply by pressing reset button 18. In one embodiment, different medication alert modules are each pre-set with a different, single timer interval, for example a four hour interval, a six hour interval, an eight hour interval, a twelve hour interval, and a twenty four hour interval. The time periods or intervals are based on standard intervals between doses of different types of medication. The time interval to be used, and thus the medication reminder device provided to the patient, may be selected by a doctor or pharmacist when dispensing the medication device to a patient, as described in more detail below, or a device with the appropriate dosage time period may be selected by the patient and purchased over the counter. In alternative embodiments, timer module 68 in a single device may include timers having different time intervals, such as the periods listed above. The appropriate dosage time interval is then set by a doctor, pharmacist, or other medical personnel when dispensing a medication.

Operation of the circuit of FIGS. 8 and 9 is as follows. The activate or start tab 65 (if present) is pulled to turn on the battery 62, which may be a relatively small and flat battery such as a watch or hearing aid battery. If the device is associated with only one time interval, no programming is required and the device is ready to use immediately. If the timer module has multiple time intervals, the alarm time period or interval is set up by pressing the reset button 18 for a pre-determined duration to select a program corresponding to a 4, 6, 8, 12 or 24 hour medication interval. The LED 22 flashes in a given sequence to verify the program selected. In one embodiment, pressing the reset button for a first duration causes the LED 22 to flash once, indicating a four hour interval. If this is not correct, the reset button is pressed for a longer interval until the LED 22 flashes twice, corresponding to a six hour timer interval, and so on. Once the desired time interval is indicated by LED 22, the optional lock or activate tab 66 is pulled to lock in the selected time interval for timer module 68.

Once the unit is turned on, the user is alerted with a sound and by illumination of the LED light. The light remains illuminated until the user presses reset button 18 once, which also starts the timer. The patient is instructed to do this as soon as they take their first dose of medication, and to repeat after each successive dose of medication. At the end of the pre-set time interval after pressing of reset button 18, when the next dose of medication is due, a signal is sent from the timer module 68 to the alarm actuator switch or controller 74, which connects the battery 62 to each alarm device 22, 64. This activates LED 22 so that it lights up or flashes, and also actuates audible alarm or piezoelectric device 64. Audible alarm device may emit any suitable alarm sound, such as a beep, voice or other sound, and may start at a low volume and then increase incrementally for a time period such as one minute. Mute button 20 may be pressed by the user if they do not want the audible alarm to go off, or want to turn off the audible alarm before it becomes too loud, for example if they are in a crowded venue such as church, theater, a meeting, or the like. Pressing of mute button 20 causes control actuator switch 74 to turn off the power supply to the audible alarm device 64. As noted above, the mute button may be omitted in alternative embodiments when the mute function is not desired or an audible alarm is not used.

After taking a dose of medicine, the user pushes reset button 18, causing the timer interval or countdown to begin again, and disconnecting the power supply or battery from the alarm devices. If the user forgets to push the reset button 18, a repeated alarm sequence reminds them to reset the timer. An early reset cutoff or protective module 70 may be used to prevent the user from inadvertently resetting the time interval early, i.e. before the pre-set time interval from the last reset button press has expired. This inactivates the reset button immediately after it is pressed, and the reset button is only re-activated when a timer period expires and the alarm signal is activated. The alert time cycle can be repeated until the battery is exhausted or the user is finished with a course of medication and discards the device.

In the embodiments of FIGS. 1 to 8, plural carrier devices are provided, each having a medication alert system, which activates one or more alarms on expiry of a different, pre-set time interval. A patient taking medication at 4 hour time intervals is provided with a wrist band, key fob, or clip having a built-in alert module with a 4 hour timer, or may purchase the appropriate device over the counter. Similar 6 hour, 8 hour, 12 hour, and 24 hour time interval reminder devices are dispensed or purchased as appropriate. This makes the medication reminder device extremely easy to use. The medication reminder devices may be of different colors or have indicia indicating the time period associated with their pre-set timer, for easy dispensing purposes. Once the selected device is turned on, all the user needs to do is to press a single reset button each time the alarm is activated, after they take their medication. The reset button is disabled and does not function after the reset button is pressed until the time interval expires.

As illustrated in the embodiments of FIGS. 1 to 5, the medication reminder system may comprise an alarm or medication alert module which is either incorporated in or attached to a wrist band, clip device, or key fob. In its simplest form, the medication reminder system is a stand alone, disposable or re-usable device and the original medication container is carried or kept separately from the device. Each time the alarm is actuated, the user or patient simply takes the prescribed dose of medication and then presses the reset button. The alarm controller or IC 60 may be programmed to repeat the alarm signals or sound the alarms in a different sequence if the reset button is not pressed during a pre-determined time interval after an initial actuation, in case the user does not notice the first alarm actuation or forgets to reset the system after taking a dose of medication. As indicated in FIGS. 3, 4 and 7, a pill compartment may be incorporated in the medication reminder carrier device so that a user can carry some medication while they are away from home, for example. In other embodiments, the medication alert module may be a stand alone unit which is simply carried in a patient's pocket or purse, or may be attached to a pill dispenser, bracelet, necklace, or other carrier device. The medication alert module may alternatively be provided in a medication container itself, with the container or medication bottle then acting as the carrier device. In one embodiment, the medication alert module may be incorporated in the cap of a standard medication container. The medication reminder system may alternatively be used as a reminder for other types of activity, not just taking medications, such as blood sugar or other periodic testing, for example.

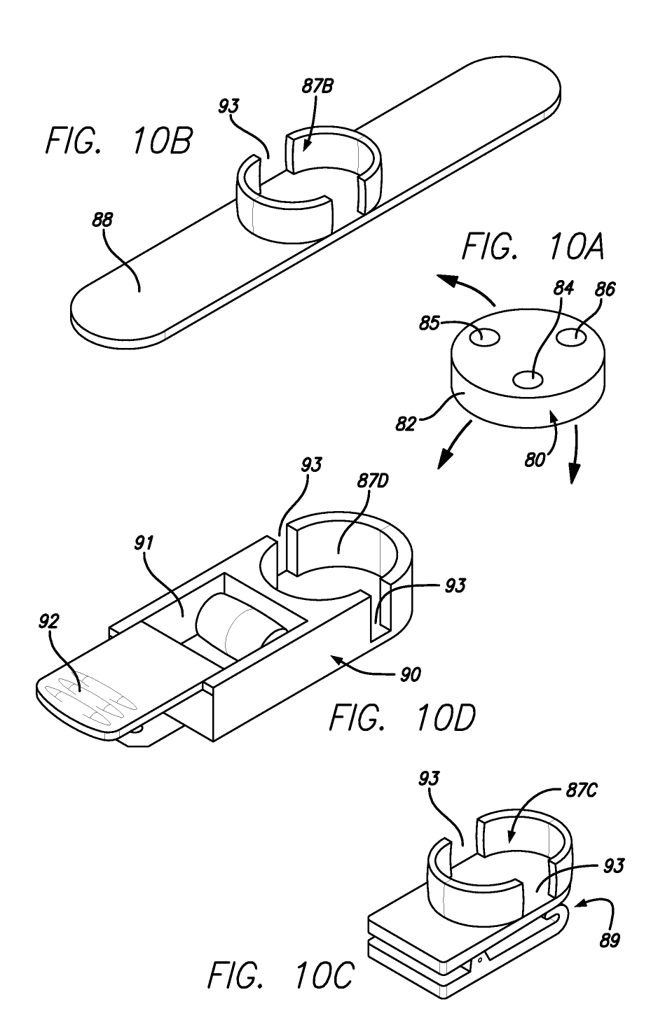

FIGS. 10 and 11 illustrate another embodiment of a medication reminder system in which a medication alert module 80 as illustrated in FIG. 10A may be selectively attached to different holders or carrier devices as illustrated in FIGS. 10B to 10D, allowing the user to choose the manner in which they wish to carry the device. In this embodiment, the medication alert module 80 comprises a disk-like outer housing 82 which has an internal compartment containing a battery as well as the control circuit for actuating alarm devices such as an LED 84 mounted on the upper face of housing 82. The control circuit may be the same as described above in connection with FIGS. 8 and 9. A speaker or the like for an audible alarm device, which may be identical to the audible alarm as described in the previous embodiments, may also be provided on the upper face of housing 82. A tactile alarm such as a vibrator may also be provided on the housing 82. A removable battery cover (not illustrated) may be located on the lower face of housing 82 to allow the battery to be replaced. Alternatively, the module 80 may be designed to be discarded after a course of treatment is complete. A reset button 85 and optional mute button 86 are provided on the upper wall of housing 82. The start and activate tabs 65 and 66 of FIGS. 8 and 9 are optional and may be omitted in this embodiment. The mute button may also be omitted if this function is not desired or no audible alarm device is present.

Module 80 of FIG. 10A may be releasably secured in a seat or recess provided on various different types of carrier or holder devices, such as a wrist band 88 as illustrated in FIG. 10B, a clip-on device 89 as illustrated in FIG. 10C, a key fob 90 as illustrated in FIG. 10D, or other devices such as pill containers, bracelets, necklaces, the lid of a standard pill container, and the like. The key fob 90 of FIG. 10D includes an optional pill compartment 91 having a slidable lid or cover 92. Similar pill compartments may be provided in alternative embodiments of the wrist band 88 and clip-on device 89 in other embodiments of the medication reminder system.

Each device 88, 89 and 90 has a seat 87B, 87C, and 87D, respectively, which receives the module 80. FIG. 11 illustrates module 80 engaged in the seat 87B of wrist band 88. Interengageable snap formations (not visible in the drawings) may be provided between the module and the respective seat for releasably securing the module in place, with each seat comprising an annular ridge or wall with diametrically opposed gaps or openings 93 to allow the module 80 to be removed for attachment to a different device or for discarding after use, as appropriate. The medication alert module 80 may be activated and reset as described above in connection with FIGS. 8 and 9.

In one embodiment, a series of modules 80 are provided, each pre-programmed with a single time period or interval, such as a four hour module, a six hour module, an eight hour module, a twelve hour module, and a twenty four hour module. The modules may be in different colors and/or indicia or have different SKUs or barcodes to distinguish one time interval setting from another. In this case, the doctor or pharmacist does not have to program the module 80 before dispensing it. Instead, they simply select the module which is programmed with the correct dosage time interval for the dispensed medication, and dispense it to the patient along with one or more carrier devices. Alternatively, the patient may purchase a module with the appropriate time period for their medication over the counter, rather than having a doctor or pharmacist dispense the medication reminder system to a patient. The module is activated either by pulling a battery tab, if provided, or pressing the reset button. In an alternative embodiment, a single timer with a series of different time intervals may be provided, and the appropriate time interval is programmed when the module is dispensed.

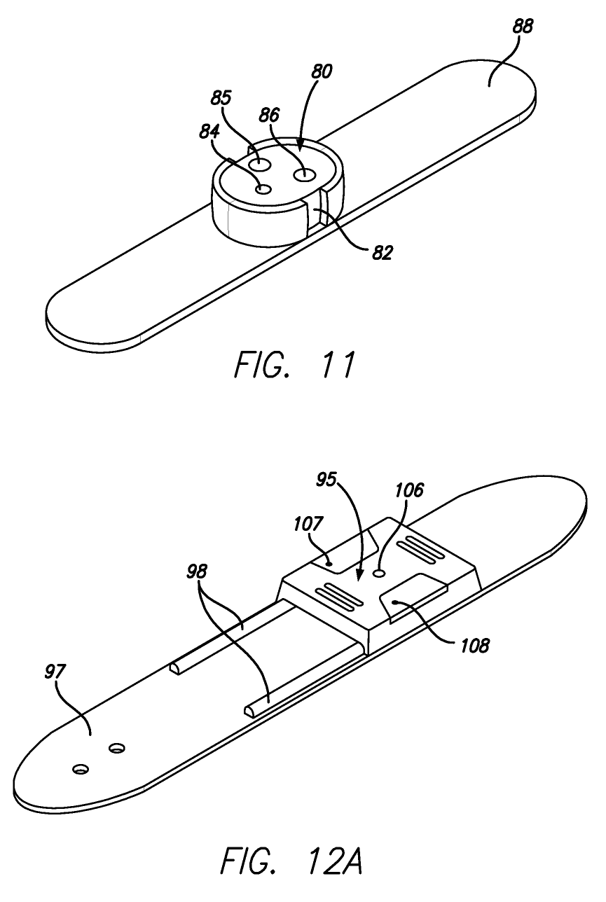

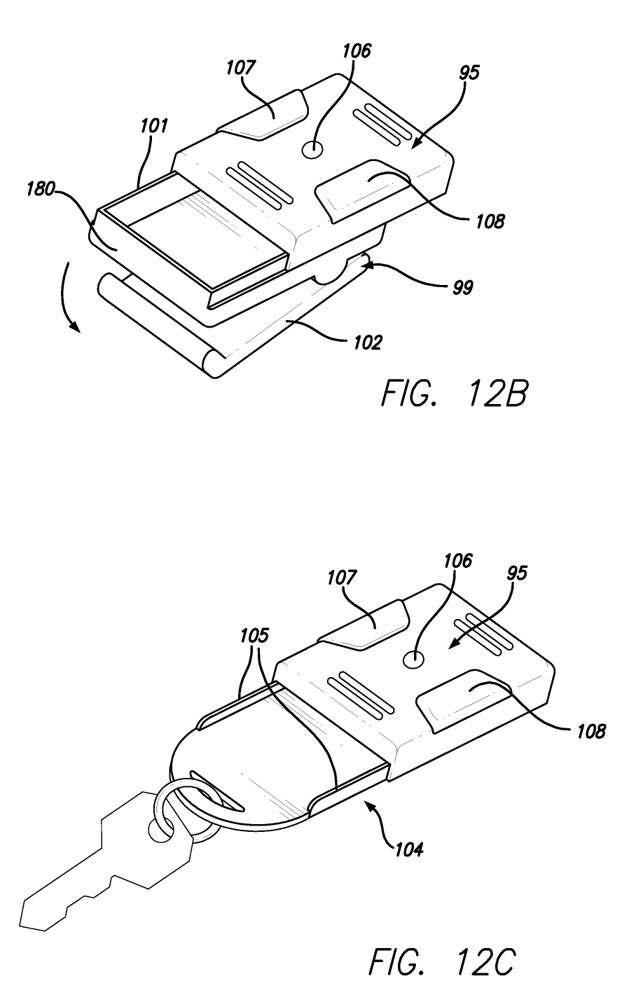

FIGS. 12A to 12C illustrate an alternative modular medication reminder system in which a medication alert module 95 is designed for sliding engagement on rails 98 provided on various different carrier devices. The medication alert module 95 is shown partially engaged with the rails 98 in each of the drawings. In FIG. 12A, the carrying device is a wrist-band 97 with rails 98 on an upper side of a central region of the band. In FIG. 12B, the carrying device is a clip-on mechanism 99 with a base 100 having a pair of rails 101 for receiving module 95. A clip member 102 is hinged to a lower surface of base 100, similar to the clip device 25 of FIG. 3, but excluding the pill compartment. In FIG. 12C, the carrying device is a key fob 104 having a pair of spaced rails 105 for slidable engagement with module 95.

As in the previous embodiments, medication alert module 95 has an internal compartment containing a battery and a control circuit which controls actuation of alarm devices such as LED 106 on the upper surface of module 95, and an audible alarm device (not visible in FIGS. 12A to 12C). A reset button 107 and optional mute button 108 are also provided on the upper surface of module 95. As described above in connection with FIGS. 10 and 11, a plurality of modules 95 may be provided, each associated with a timer having a different time interval corresponding to different medication dosage intervals. The control circuit in this embodiment may be the same as the control circuit described above in connection with FIGS. 8 and 9, optionally excluding the battery start or activation tab 65 and/or the timer lock-in tab 66, particularly when each module 95 is pre-programmed with only one time interval.

In addition to the alarm LED, any of the previous embodiments may also include a battery indicator which flashes if the battery power is low. In other embodiments, timer module 68 and alarm actuator switch or controller 74 may also be programmable with two or more different time intervals for different medications, and with different alarm signals or devices. In one embodiment, different color LEDs may be provided on the medication alert module or housing. For example, one medication with a four hour time interval may be associated with a red LED which flashes on expiry of a four hour time interval, while another medication with a twelve hour dosage time interval may be associated with a green LED which flashes on expiry of a twelve hour time interval.

In the above embodiments, the medication alert assembly or module is initially activated by pulling a battery tab or by pressing the reset button, for example. In an alternative embodiment, any of the medication alert modules described above may be activated by a remote, hand held device operated by pharmacist, which emits a signal to activate the device. In one example, the activation device may be a magnetic device which can be simply scanned over a medication alert module prior to dispensing the module to a patient.

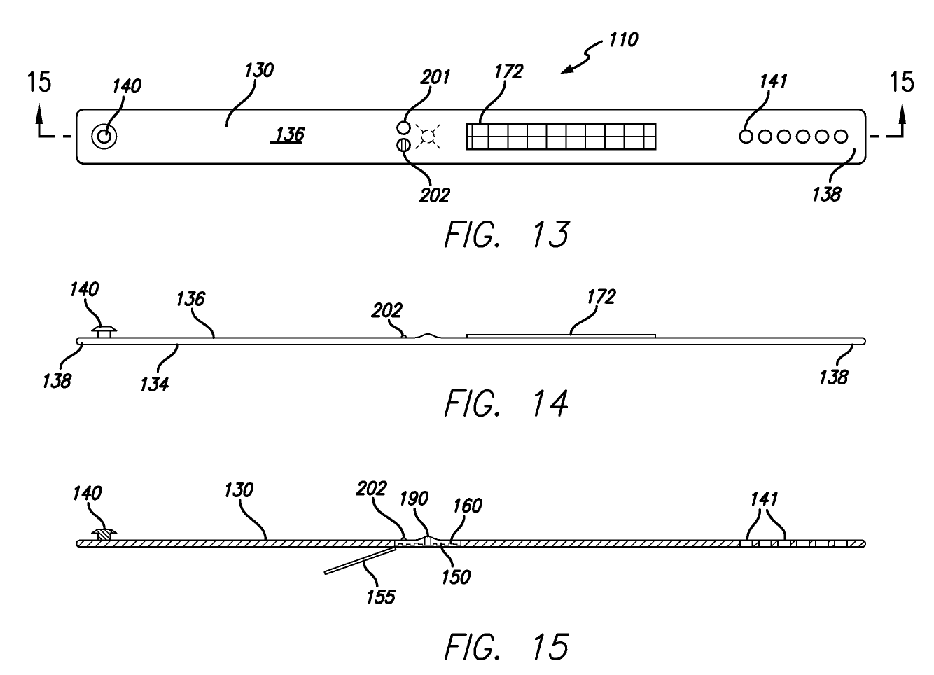

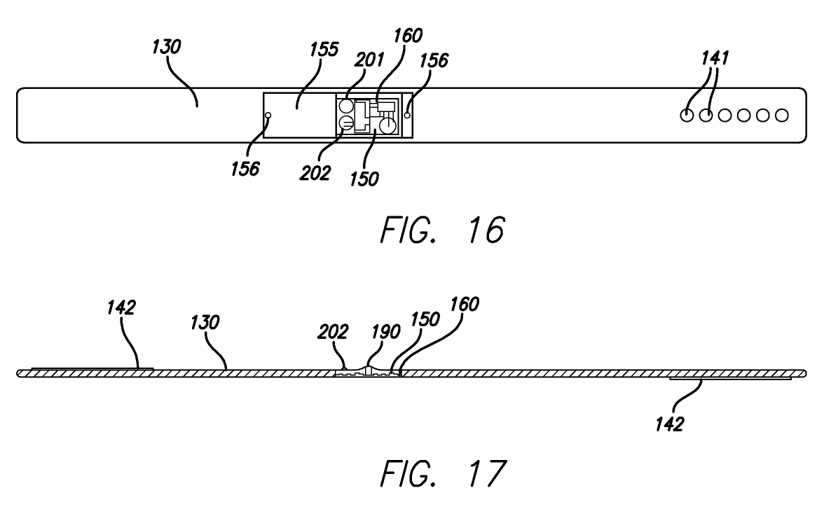

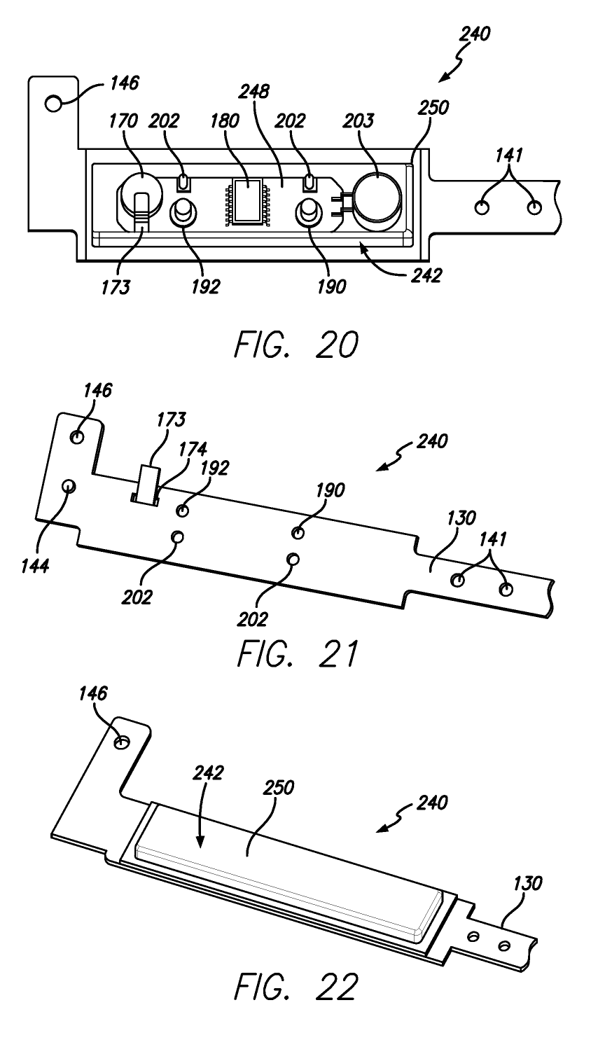

FIGS. 13 to 16 illustrate another embodiment of a medication reminder device or system 110 comprising a wrist band for wearing on a human appendage such as a wrist with a medication alert assembly incorporated at least partially within the thickness of the wrist band. Unlike several of the previous embodiments, in which the medication alert assembly was in the form of a stand-alone module releasably or permanently attached to a carrier device, components of the medication alert assembly of this embodiment are directly incorporated in the wrist band. This embodiment has a lower, flatter profile than the previous wrist band embodiments of FIGS. 1, 2, 10, 11, and 12. The wrist band 110 comprises a wrist strap 130 that has a top surface 136, a bottom surface 134, and a compartment or cavity 150 at least partially within the strap 130. The compartment 150 may have an access opening formed in the bottom surface 134 of the strap 130, as illustrated in FIGS. 15 and 16, or the access opening may be in the top surface 136 (not shown). A flap 155 for substantially sealing the access opening of compartment 150 may be included, as illustrated in FIGS. 15 and 16. Such a flap 155 may include a magnetic lock (not shown), or a mechanical lock 156 for selectively locking the flap 155 in a closed position covering the compartment 150. Alternatively, in a disposable version of the wrist band, the flap may be permanently closed over the opening after installing the components of a medication alert system or circuit within the compartment. Alternately, a separate compartment or module 150 containing the electronic components of the medication alert assembly may be attached, such as by ultrasonic welding, for example, to either the bottom surface 134 or top surface 136 of the strap 130, as illustrated in the alternative embodiment of FIGS. 20 to 22 which is described in more detail below.

A control circuit 160 (FIG. 18) for operating one or more alarm devices 201, 202 is located in compartment 150, as illustrated in FIGS. 13 and 16. The alarm devices may be contained within compartment 150 so as to be visible through a transparent window in the upper surface 136 of the device above compartment 150, or may be mounted on the upper or lower surface of the wrist band, as appropriate. An optional photovoltaic cell power source 172 providing power to circuit 160 and alarm devices 201 and 202 may be adhesively secured on the upper surface 136 of strap 130, as indicated in FIG. 13. A reset button 190 is also provided in or above compartment 150, as illustrated in FIG. 15.

A suitable fastener mechanism 140, 141 is provided for securing opposite ends 138 of strap 130 about a wearer's wrist 14 as illustrated in FIG. 19. In FIGS. 13 to 16, the fastener mechanism comprises a stud or snap button 140 at one end of strap 130 and a series of spaced openings 141 extending up to the opposite end 138 of strap 130. FIG. 17 illustrates an alternative fastener mechanism comprising mateable strips 142 of hook and loop fastener material at opposite ends and on opposite faces of the strap, which are placed one on top of the other to secure the wrist band about the wearer's wrist. The device of FIG. 17 is otherwise identical to that of FIGS. 13 to 16 and like reference numerals are used as appropriate. In another embodiment, the wrist band 130 may be a continuous band of an elastomeric material so as to stretch over a person's hand temporarily. Other types of attachment means may be devised, such as adhesive, mechanical multi-use snaps, buckles similar to watch strap buckles, or the like, as is known in the art.

Control circuit 160 is illustrated in FIG. 18 together with alarm devices 201 and 202, and an optional additional alarm device 203. Circuit 160 includes a power source which may be a relatively flat battery 170, such as a hearing aid or watch battery, a timer module 180, and externally operable reset switch 190. The battery may be a disposable lithium or alkaline battery, or a re-chargeable battery. In one embodiment, as illustrated in FIG. 13, the power source for the alarm devices and control circuit may be at least one photovoltaic cell 172 affixed to the top surface 136 of the wrist strap such that the circuit may be powered by ambient light. In this case, rechargeable battery 170 is also included to provide power in the absence of ambient light, and the control circuit is connected to both photovoltaic cell 172 and the rechargeable battery 170. In the illustrated embodiment, the timer module 180 has a plurality of timers 210 which each determine a different delay time between alarm activations, the circuit 160 activating the alarm devices 201, 202, 203 after the selected delay time has expired. The reset switch 190 deactivates the alarm devices 201, 202, 203 and re-starts the selected timer 210. The circuit 160 may be formed on a circuit board, or integrally within the strap 130 (not shown). The circuit 160 is at least partially contained within the compartment 150.

As noted above, control circuit 160 in one embodiment includes a plurality of timer switches 210, each of which sets a different delay time tᵢ between alarm activations. For example, one timer switch 210 may be included for each of the following delay times: t₁=2-hours, t₂=4-hours, t₃=6-hours, t₄=8-hours, t₅=12-hours, t₆=24-hours, t₇=48-hours, t₈=72-hours, or other delay times as needed. In a wrist band 130 used for reminding patients to take their antibiotics, for example, one timer switch 220 may be included for each of the following standard antibiotic dosage times: 6 hours, 8 hours, 12 hours and 24 hours. Pain management medications, such as opioids, NSAIDs, muscle relaxants and non-opioid analgesics, are typically usually taken every 2 hours, 3 hours, 4 hours, 6 hours, 8 hours, 12 hours, 24 hours, or 72 hours. Cardiology, thyroid, diabetic, oral contraceptive, urology, blood thinner, Alzheimer, weight loss, other endocrine and metabolic medications, and vitamins are taken every 8 hours, 12 hours or 24 hours. Gastroenterology, Parkinson, hormone or other OB/GYN, psychiatry, oncology, asthma, neurology, anxiolytics, ear/nose/throat, and diabetic sugar level testing medications, as well as most over-the-counter medications, are typically taken every 4 hours, 6 hours, 8 hours, 12 hours or 24 hours. Most drug classes fall into one of the above “Hour Interval Categories,” and as such the medication reminder device 110 may include one timer switch for each delay time in any one such Hour Interval Category. The selected timer switch or switches 210 may be activated by a doctor, pharmacist, or other medical personnel on dispensing medication to a patient.

The top surface 136 of wrist band 130 may be color coded to correspond with one such Hour Interval Category, so that a pharmacist may issue a green wrist band to a patient when fulfilling an antibiotic prescription, for example. The medication reminder device may include one or more alarm devices such as an audio transducer 201, which may be a small speaker or piezoelectric buzzer, a visual alarm such as an LED 202, and/or a vibrating tactile alert device 203, such as a small motor that spins an off-center weight, as illustrated in FIG. 18. One or more alarm devices may be provided, for example both an audible and a visual alarm, or audible, visual, and vibrating tactile alert devices. Any LEDs 202 are mounted on the top surface 136 or in the compartment 150 beneath a transparent portion of the top surface so that they are visible to the user. If an audio transducer 201 is used, it is also mounted in the top surface 136 or immediately beneath the top surface so as to emit an alarm signal which is audible to the user. A vibrating or tactile alert device 203 is mounted on the bottom surface 134 or immediately inside the bottom surface so that vibrations are felt by a user wearing the device. One or more LEDs 202 may be provided, each of which flash when activated by the circuit 160, and different color LEDs may be provided for different medications. If more than one time switch 210 is included, one LED 202 may be associated with each alarm delay time tᵢ. For example, a green LED 202 may be used to signify a four-hour delay time, while a red LED 202 may be used to signify a six-hour delay time. Alternatively, a single LED 202 may be used with at least two distinct flashing patterns to signify the expiration of different delay times t₁ and t₂. Likewise, two distinct audio alarms 201, or two distinct tactile alarms 203 may be used to signify the expiration of different delay times t₁ and t₂.

Where plural alarm devices are provided, such as a combination of the audio transducer 201, the at least one LED 202, and the tactile alert means 203, a selector switch 120 may be included for selecting between at least two types of alarm devices, or between one or both types of alarm devices, as illustrated in FIG. 18. The tactile alert device 203 may be the same for all alarm activations, while the LED 202 alarm activations may be distinct based on the delay time tᵢ that has expired. A selection switch may also be included to allow the dispenser of the medication reminder device to select the appropriate timer 210 to be activated based on the medication dispensed, or more than one timer if two or more different medications with different dosage times are dispensed.

In one embodiment, circuit 160 is embedded in a disposable, one-use wrist strap or band 130. However, the circuit 160 may also be embedded in a stand-alone enclosure that attaches permanently or releasably to a wrist band or strap, a necklace, a set of keys, a clip device or the like, as described above in connection with FIGS. 1 to 12. Further, the wrist strap or band 130 may be a non-disposable plastic, leather, or fabric wrist strap. In such an embodiment, the battery 170 is accessible in the compartment 150 and replaceable. A battery charge indicator LED (not shown) may also be included that indicates the charge status of the battery 170, blinking periodically when the battery 170 needs to be replaced, for example. In an alternate embodiment, the circuit 160 is sealed in the compartment 150 with access only to the reset switch 190.

An alternative one time medication reminder device 240 is illustrated in FIGS. 20 to 22. Some parts of the device of FIGS. 20 to 22 are identical to corresponding parts of the embodiments of FIGS. 13 to 19, and like reference numbers are used for like parts as appropriate. In this case, wrist band 130 is wrapped around a wearer's wrist and a selected opening 141 engages stud or snap button 144 which faces outwards. The projecting end flap 145 is then folded over snap button 144 and the wrapped strap end, and opening 146 is snap engaged over button 144. The wrist band 130 can then only be removed by cutting through strap 130. This is similar to a patient ID bracelet as used in hospitals. A similar one time fastener device may be used for attaching the wrist bands in FIGS. 13 to 19, or in any of the wrist band devices of the preceding embodiments, where they are intended to be disposable, one-time usage medication reminder devices. The one time fastener device of FIGS. 20 to 22 may also be replaced by the reusable fastener of FIGS. 13 to 18 in other alternative embodiments.

In this embodiment, a medication alert module 242 is adhered or bonded to the lower surface of wrist strap 130. Module 242 comprises a control circuit similar to the circuit of FIG. 18 mounted on a circuit board 248 enclosed within outer casing 250. Portions of the outer casing 250 are removed in FIG. 20 to reveal the control circuit. Casing 250 may be transparent. The circuit includes an integrated circuit or controller 180 incorporating one or more timers, a power supply or battery 170, and one or more alarm devices. In this case, two LEDs 202 are provided, along with a tactile alarm device 203. An audible alarm device or transducer 201 may be provided in addition to device 203 or in place of device 203 in other embodiments. A reset switch 190 and a circuit test switch 192 are also provided on the circuit board. Both switches 190, 192 and the LEDs 202 project from the module 242 out through openings in the upper surface of wrist band 130, as seen in FIG. 21. Further, a non-conductive battery tab 173 (FIGS. 20 and 21) may be disposed between the battery 170 and the circuit board 160 so that while the device 240 is not in use, such as while being transported for example, the circuit 160 is not powered, thereby conserving battery life. Such a battery tab partially projects out of a battery access slot 174 in the strap 130 such that the battery tab 173 may be removed manually from outside of the compartment 150 to actuate the circuit 160.

In this embodiment, reset switch 190 is used to start the timer in IC 180 at the start of a cycle of medication, and to turn off the alarm devices and re-start the timer when the programmed time interval has expired and a dose of medication has been taken. Circuit test switch 192 may be used to test that the alarm devices are working properly.

The medication alert assembly or module of any of the preceding embodiments may be associated with any suitable carrier or holder designed to be attached to the user or the user's clothing, or carried by the user in a pocket, purse or the like. The carrier device in any of the embodiments may be a wrist band, pill container, clip device, key fob, bracelet, necklace, locket, or the like. In another embodiment, the medication alert module may be mounted in or on a cap adapted to close a standard pill container or medication bottle. Where the carrier device is a wrist band, the medication alert module may be incorporated into a conventional watch (not shown), an anklet (not shown), or the like. A modular system may be provided in which a medication alert module may be releasably secured to any one of a plurality of different carrier devices, as in the embodiments of FIGS. 10 to 12, so that a patient may select the device which they prefer. Alternatively, the medication alert module may be permanently secured to a disposable or re-usable carrier device, or components of a medication alert assembly may be mounted in or on the carrier device itself, with some or all of the components contained within a cavity formed in the carrier device.

The medication reminder device and method described in the above embodiments can effectively prompt a patient to take medication doses at prescribed intervals. When it is a stand alone device separate from the actual medication container, the patient does not have to transfer prescribed medications from one container to another. However, alternative embodiments described above incorporate a pill enclosure so that a patient may carry medication with the reminder device when traveling or otherwise away from home. The medication reminder device is easy to use, only requiring the patient to press the reset button when each dose of medication is taken.

As described above, a single medication reminder device may be programmable with different dosage time periods or intervals, or different medication reminder devices may be provided, each with a single timer corresponding to a different dosage time interval. In the latter case, the different devices may be provided in different colors or with different bar codes or other insignia corresponding to the associated standard dosage time period or interval. Such devices may be dispensed by a pharmacist along with a new medication, or may be purchased over the counter by a patient. Different colors may be provided for different categories of medication, as noted above. The device is relatively inexpensive and may be designed to be discarded after a prescription is finished. In this case, an optional kill switch may be incorporated to allow the user to turn off the device before it is discarded, so that the alarm does not continue to go off after it is discarded. Alternatively, the device may be re-usable for repeated prescriptions.

The medication reminder system of the above embodiments is easy to use and does not need to be programmed or set up by a patient. Instead, plural reminder devices may be pre-programmed with pre-determined dosage time intervals, or a device with multiple time settings is easily programmed by a doctor or pharmacist simply by switching on the appropriate timer from a plurality of different timers provided in the device. In each case, the patient does not have to worry about setting up the reminder device. All the patient needs to do is to simply press a reset button each time the alarm is activated, after taking the dose of medication. In an alternative embodiment, a device with multiple time settings is easily programmed by a patient simply by switching on the appropriate timer from a plurality of different timers provided in the device. Although a modular medication reminder system is described in the above embodiments, the reminder system may alternatively used to provide reminders at successive identical time intervals for users to perform tasks other than taking medication, such as testing blood sugar levels or performing other timed functions.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

1. A medication reminder system, comprising:
a carrier device; and
a medication alert assembly associated with the carrier device;
the medication alert assembly comprising at least one alarm device which produces a first alarm signal to remind the user to take a first selected medication, a controller which controls actuation of the first alarm device, a timer associated with the controller having at least a first pre-set time interval corresponding to a standard dosage time interval in hours between doses of the first selected medication, the controller activating the alarm device to emit an alarm signal on expiry of the first pre-set time interval, and a reset switch operable by the user which deactivates the alarm device and restarts the timer after each alarm activation.

2. The system of claim 1, wherein the carrier device comprises a strap which is secured around an appendage of user, the strap having an outer surface which faces outwardly and an inner surface adjacent the appendage when worn by a user.

3. The system of claim 2, wherein the strap includes an internal cavity and the medication alert assembly is located at least partially within the cavity.

4. The system of claim 2, wherein the strap comprises a wrist band having two ends and a fastener mechanism which secures the wrist band about a user's wrist.

5. The system of claim 4, wherein the fastener mechanism is a one-use mechanical fastener, and the wrist band is disposable after completion of a pre-determined course of medication.

6. The system of claim 2, wherein the alarm device comprises at least one light emitting diode (LED) visible on the outer surface of the strap.

7. The system of claim 2, wherein the alarm device comprises an audio transducer.

8. The system of claim 2, wherein the alarm device comprises a vibrating tactile alert device located at the inner surface of the strap.

9. The system of claim 1, comprising a plurality of different carrier devices, each carrier device having a medication alert assembly containing a timer pre-set with a pre-determined time interval different from the pre-set time intervals of the other carrier devices.

10. The system of claim 9, wherein the pre-set time intervals associated with the respective carrier devices comprise at least four hour, six hour, eight hour, twelve hour, and twenty four hour intervals.

11. The system of claim 1, further comprising a compartment integrally formed within the carrier device, at least the controller and timer of the medication alert assembly being enclosed within the compartment.

12. The system of claim 1, wherein the medication alert assembly comprises a medication alert module releasably secured to the carrier device.

13. The system of claim 12, wherein the alarm device comprises a light emitting device mounted on an outer surface of the module.

14. The system of claim 12, wherein the alarm device comprises an audible alarm device.

15. The system of claim 14, further comprising a mute switch operable by a user to disable the audible alarm device.

16. The system of claim 12, wherein the alarm device comprises a tactile alarm device.

17. The system of claim 12, further comprising a plurality of different medication alert modules, each module having a timer pre-set with a single pre-set time interval corresponding to a medication dosage time interval different from the pre-set time intervals associated with the other medication alert modules.

18. The system of claim 17, wherein the medication alert modules have respective pre-set time intervals, comprising at least four hour, six hour, eight hour, twelve hour, and twenty four hour time intervals.

19. The system of claim 17, wherein the different modules have different distinguishing characteristics.

20. The system of claim 19, wherein the distinguishing characteristics comprise different bar codes corresponding to the different time intervals.

21. The system of claim 19, wherein the distinguishing characteristics comprise different colors corresponding to the different time intervals.

22. The system of claim 1, wherein the medication alert assembly includes at least two different alarm devices connected to the controller and producing different alarm signals when activated.

23. The system of claim 22, wherein the alarm devices comprise different color light emitting devices.

24. The system of claim 22, wherein the alarm devices comprise a visual alarm device and an audible alarm device.

25. The system of claim 22, wherein the medication alert assembly includes at least one visual alarm device, at least one audible alarm device, and at least one tactile alarm device.

26. The system of claim 1, wherein the carrier device comprises a clip for attaching to a wearer's clothing or accessory.

27. The system of claim 1, wherein the carrier device comprises a key fob.

28. The system of claim 1, wherein the timer comprises a plurality of timer switches associated with different pre-set time intervals corresponding to different standard medication dosage time intervals, the medication alert assembly further comprising a selector switch which activates at least a first timer switch corresponding to the dosage time interval of a selected medication to be taken by the user.

29. The system of claim 28, further comprising a selector switch which activates a second timer switch corresponding to a second pre-set time interval different from the first pre-set time interval and comprising a pre-determined number of hours corresponding to a standard dosage time interval in hours between doses of a second selected medication, the controller activating a first alarm signal on expiry of the first pre-set time interval and activating a second alarm signal on expiry of the second pre-set time interval, the reset switch being operable by the user to deactivate the respective first or second alarm signal and restart the first or second pre-set time interval, respectively, after each alarm activation.

30. The system of claim 1, wherein the medication alert assembly has a plurality of alarm devices which each produce an alarm signal different from the alarm signals produced by the other alarm devices to remind the user to take a selected medication, each different alarm signal being associated with a different selected medication, the timer having a plurality of different pre-set time intervals each associated with a respective alarm device, each pre-set time interval comprising a pre-determined number of hours corresponding to a standard dosage time interval in hours between doses of the selected medication associated with the respective alarm device, and the controller activates the respective alarm signals on expiry of the pre-set time intervals associated with the respective alarm devices, the reset switch being operable by the user to deactivate the respective alarm device and restart the pre-set time interval associated with the respective alarm device on the timer after each alarm activation.

31. The system of claim 30, wherein all of the medications are in the same general dosage time category.

32. The system of claim 31, wherein the carrier device comprises a wrist band for attachment about a user's wrist, the wrist band having an outer surface of a pre-determined appearance corresponding to the medication category associated with the timer's pre-set time intervals.

33. The system of claim 32, further comprising a plurality of wrist bands each having a medication alert assembly associated with medications having different dosage time categories, the wrist bands having different appearances to distinguish between the different medication categories.

34. The system of claim 33, wherein the wrist bands comprise a first color wrist band associated with dosage time categories for antibiotic medications, a second color wrist band associated with dosage time categories for pain management medications, a third color wrist band associated with dosage time categories for endocrine and metabolic medications and vitamins, and a fourth color wrist band associated with dosage time categories for other medications.

35. The system of claim 1, wherein the carrier device comprises a medication container having a closure.

36. The system of claim 35, wherein the medication alert assembly is associated with the closure of the medication container.

37. A reminder system for reminding a user to carry out a pre-determined action at pre-determined time intervals, the system comprising:
a plurality of alert modules each comprising an outer housing, at least one alarm device which produces a first alarm signal to remind a user to take a pre-determined action, a controller which controls actuation of the first alarm device, a timer associated with the controller and having a pre-set time interval, the controller activating the alarm device to emit an alarm signal on expiry of the pre-set time interval, and a reset switch operable by the user which deactivates the alarm device and restarts the timer after each alarm activation, the timers in the respective alert modules having different pre-set time intervals; and
at least one carrier device which carries an alert module and which can be worn or carried by a user.

38. The reminder system of claim 37, comprising a plurality of carrier devices, each alert module being associated with a respective carrier device.

39. The reminder system of claim 38, wherein each alert module is incorporated in the respective carrier device.

40. The reminder system of claim 37, wherein the carrier devices comprise wrist bands.

41. The reminder system of claim 40, wherein the wrist bands are of different colors corresponding to the different pre-set time intervals.

42. The reminder system of claim 37, wherein the at least one carrier device includes a plurality of different carrier devices, each module being releasably securable to a selected carrier device.

43. The reminder system of claim 42, wherein each module is coded to indicate the associated time interval.

44. The reminder system of claim 43, wherein each module has a pre-determined bar code on its outer surface corresponding to the pre-set time interval associated with the timer in the respective module.

45. The reminder system of claim 43, wherein each module is of a pre-determined color corresponding to the associated time interval.

46. The reminder system of claim 42, wherein the carrier devices comprise at least a wrist band attachable about a wearer's wrist, a key fob, and a clip device for releasable attachment to a user's clothing or accessory, each carrier device having a seat for releasable engagement with the alert module.

47. The reminder system of claim 37, wherein the different pre-set time intervals comprise different medication dosage time intervals in hours.

48. A medication reminder method, comprising:
selecting a disposable medication alert module having a timer programmed with a dosage time interval corresponding to the time interval between doses of a prescribed medication;
starting the timer of the selected disposable medication alert module after a dose of medication is taken;
activating an alarm device on the medication alert module after expiry of the dosage time interval to alert the user that it is time to take the next dose of medication;
resetting the timer to start timing the next dosage time interval after a second dose of medication is taken;
repeating the activating and resetting steps until a course of medication is completed; and
discarding the medication alert module after the course of medication is complete.
